(19) United States
(12) Patent Application Publication
(10) Pub. No.: US 2026/0254635 A1
(43) Pub. Date: Aug. 27, 2026

(54) SYSTEMS AND METHODS FOR VERIFYING AND MANAGING MULTIPLE CARD VERSIONS

(71) Applicant: Capital One Services, LLC, McLean, VA (US)

(72) Inventors: Kevin Osborn, Newton Highlands, MA (US); Ian Prince, Nottingham (GB); Tomasz Ondrusz, Normandy (GB); Sophie Bermudez, Bend, OR (US)

(21) Appl. No.: 19/064,146

(22) Filed: Feb. 26, 2025

(51) Int. Cl. H04L 9/08; H04L 9/06; H04L 9/14; H04L 9/32; H04W 12/47

(52) U.S. Cl. CPC H04L 9/0897; H04L 9/0643; H04L 9/14; H04L 9/3242; H04W 12/47

(57) ABSTRACT

The disclosed systems and methods are directed to secure retrieval of proprietary data associated with converted applet file stored on a contactless card. The data is stored in a hidden file not referenced in the capability container file. The file may then be directly read by a NFC command specifying the name of the file, for example, as a command parameter. One aspect of the disclosed systems and methods involves an access control bit associated with a specific file. The access setting can be statically set at personalization time. Another aspect involves resetting the flag bit following every read operation directed at the proprietary file. The access state can then be reset to an active state by an explicit write instruction generated as an NDEF encapsulated write command. Another aspect may include a command sequence for setting the access flag and returning the version number during a single read operation.

### FIELD OF THE DISCLOSURE

The present disclosure is generally related to wireless interactions with a contactless card and more specifically to optimizing wireless data retrieval from a contactless card.

### BACKGROUND

One important aspect of application and/or applet performance diagnosis is verification of an associated version number. Such information could be potentially useful to the teams which are trying to triage distinct operational irregularities for a particular device running the application and/or applet. For example, version number may comprise data that dictates a cryptographic processing of a message generated by a contactless card. If specific data fields in a version number are changed, the processing of data may also change in accommodation. Accordingly, any changes in the generated message (e.g., message length, cryptographic routines, etc.) may be indicated by data values in the version number which is an important diagnostic and verification tool for vendors and developers. However, there, there is a need for a mechanism for both maintaining and tracking the version number at various stages in a lifecycle of a card process.

These and other deficiencies exist. As such, there is need for an improved system and process which allows for both maintaining and tracking the version number at any point during an active cycle of an applet operation.

### SUMMARY OF THE DISCLOSURE

In some aspects, the techniques described herein relate to a system for enabling applet version identification during active life cycle of a contactless card, the system comprising: a contactless card having a processor and a memory. The memory storing a plurality of cryptographic key comprising a first key, a second key, a third key, a first data file and one or more data parameters comprising an access flag for the first data file, wherein the first data file stores an applet version number for a first applet. The contactless card may further comprise a near-field communication (NFC) tag for wireless communication with an intermediary device running a first application. The system may also include a server communicatively coupled with the contactless card via the intermediary device. The server may comprise a processor and a memory. The memory of the server may be storing n second application in communication with the first application running on the intermediary device, and one or more cryptographic keys comprising the first key. The processor of the server may be configured to: generate a write command for setting a value of the access flag associated with the first file, generate a message authentication code (MAC) for the write command using the first key, transmit a data packet comprising the write command and the generated MAC, via the first application, to the first applet executing on the contactless card, wherein the data packet is validated by the first applet using the first key, and wherein upon successful validation of the data packet, the access flag is set to the value specified in the write command.

In some aspects, the techniques described herein relate to A method for secure verification of an applet version number stored on a contactless card, the method comprising: storing, by the contactless card, the applet version number in a first file associated with a first file name, wherein the first file name is not referenced in a capability container stored on the contactless card; generating, by a server, a read command for retrieval of the applet version data, wherein the read command comprises one or more parameters including the first file name; transmitting, by the server, the read command to the contactless card; and transmitting, by the contactless card, a response to the server, the response comprising the applet version number, wherein the response is provided, by the contactless card, based on identifying the first file name in the read command.

In some aspects, the techniques described herein relate to a method for active retrieval of an applet version number from a contactless card, the method comprising: storing a data flag in a memory of the contactless card, wherein a value of the data flag corresponds to an access state of a first file storing the applet version number; generating, by a server, a write command for setting a value of the data flag; generating, by the sever, a first message authentication code (MAC) for the write command, using a first key stored on the server; transmitting, by the server, a data packet comprising the write command and the generated MAC, to the contactless card; verifying, by the contactless card, the first MAC associated with the write command, using the first key stored on the contactless card; setting, by the contactless card, the value of the data flag associated with the first file; and returning the applet version number in response to one or more incoming read request based on the value of the data flag.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments of the invention.

FIG. 1 illustrates a system implementation, in accordance with some embodiments of the present disclosure.

FIG. 2 illustrates a process of retrieving an applet version data identified by a hidden file name not included in the NFC data exchange format (NDEF) capability file of the contactless card, in accordance with some embodiments of the present disclosure.

FIG. 3 illustrates various exemplary processes for NDEF-based retrieval of data by setting access attributes of a data file stored on a contactless card, in accordance with some embodiments of the present disclosure.

FIG. 4A illustrates an exemplary process flow diagram for retrieval of proprietary or sensitive data stored in a hidden file on contactless card, in accordance with some embodiments of the present disclosure.

FIG. 4B illustrates an exemplary process flow diagram for NDEF-based retrieval of sensitive data from a contactless card based on an file access flag setting, in accordance with some embodiments of the present disclosure.

FIG. 5 illustrates a block diagram of an exemplary system, in accordance with some embodiments of the present disclosure.

### DETAILED DESCRIPTION

The following description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Furthermore, the described features, advantages, and characteristics of the exemplary embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

Providing mechanisms of access to various data records associated with a card applet (e.g., stored and executed on a contactless card) is helpful during the both the manufacturing/personalization phase of the card as well as the active life cycle of the card applet and the contactless card onto which it is stored. Life cycle information reveals information about the state of the card. As such one aspect of the present disclosure describes a method for run-time retrieval of the version number data associated with an applet stored on a contactless card. The retrieval process may be facilitated via a near-field communication (NFC) read of the contactless card by a reader device. An NFC read command may be generated upon entry of a contactless card into an NFC range of the reader device. The NFC read request and/or command may be operative to initiate the generation of a one-time password (OTP) from the contactless card, which may be retrieved across a secure session established between the card and the command issuing entity (e.g., the reader device, or a remote server communicatively couple to the card via the reader device). In general, readable data files associated with a card applet are listed in an NDEF capability container file that may be stored on the contactless card. Therefore a read command directed to a card applet may trigger access and/or transmission of data associated with the applet file in the capability container file. The data may be communicated to the requesting entity across a secure session using cryptographic keys stored on the card.

An applet version number corresponding to a card applet may be stored on the contactless card during a card personalization process (e.g., represented in the applet code). However, data corresponding to a card-specific applet version number may be considered as sensitive data based on software information encoded therein. Therefore, there may be a need to control and/or restrict read access to such data. In most cases, retrieval of such access-restricted data (e.g., an applet version number) via a read command (e.g., an NDEF read request) may only be allowable while the card is in a personalization state and not allowed when the card is in an active state. As such, version number data may not be made readable (stored as an NDEF readable data file exposed in the capability file container). However, there may be need to access this data given its diagnostic utility such as identifying underlying encryption code and/or functionality associated with the applet source code.

In accordance with some embodiment of the present disclosure, access-restricted applet data (e.g., applet version number (VN), corresponding to an NDEF applet) is provided as an accessible parameter when the card is active. However in order to protect the applet VN data against arbitrary exposure and/or unintended reads, it is stored under a hidden file name not referenced in a capability container file of a contactless card (e.g., proprietary data file). Therefore, the applet VN data remains hidden with respect to an NDEF reading application transmitting a read command to the card applet, unless the hidden file name is specified in the read command, for example as a parameter. In this way the applet VN data remains accessible for diagnostic purposes by an authorized entity, while remaining protected against arbitrary exposure and/or unintended reads.

In accordance with some embodiment of the present disclosure, access-restricted applet data (e.g., applet version number (VN), of an NDEF applet) is provided as an access-restricted data parameter associated with an access flag. The access flag may be configured for controlling access to applet version data when the card is active. In accordance with some embodiments, the access flag may be set with a write and/or an update binary command (e.g., an NDEF write command). However, since the write command may be operative to alter the operation of an applet and/or the contactless card, in some embodiment, the write command for setting an access flag associated with an applet data file, may be encrypted and validated with a secret key that is distinct from the card keys for establishing secure communication with a remote server (e.g. session encryption and/or decryption key and MAC generation/validation key). The write command may be issued as a single command to set the value of access flag for an applet data file. the applet version number may then be returned in response to a subsequent read of the contactless card (e.g., read request for the applet data file) based on the value of access flag parameter. In some embodiments, the write command may be inserted into a multi-operation read command sequence to set the access flag value of the applet data file and read out the data content during a single actuation of the contactless card. In some embodiments, the access flag may be reset automatically every time the associated data file is read out to disallow subsequent reading of the version number, or it may persist until it is reset by an encrypted write command.

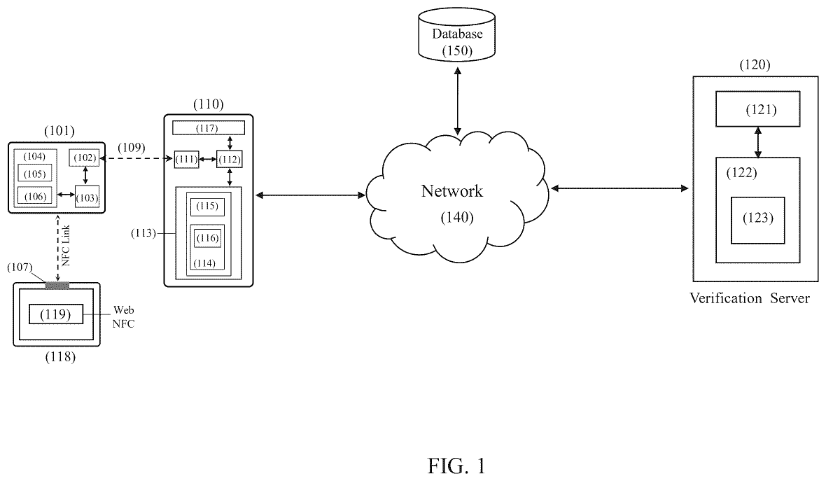

FIG. 1 illustrates a system 100 according to an example embodiment. The system 100 may comprise a contactless card 101, a user communication device 110 and/or computing device 118, a server 120, a network 140 and a database 150. Although FIG. 1 illustrates single instances of components of system 100, system 100 may include any number of components. Example 100, of FIG. 1, illustrates an exemplary representation of a contactless card 101 configured with an NFC interface/tag 102 and a user mobile device 110 configured with an NFC reader unit 111. The contactless card may comprise an integrated processor 103 and memory 104 that may store, for example, user identifying and/or authenticating information as near field communication (NFC) transmittable data (e.g., NFC Data Exchange Format (NDEF)). The integrated memory 104 may also store one or more applets 105 that may be communicatively coupled to one or more applications 114 running on the user mobile device 110 (e.g. NFC reading application and/or API 115 for facilitating one or more wireless reads of the contactless card 101 and/or a WebNFC-based browser 116).

The card-integrated memory may further store one or more data files and/or applet file components 106 associated with the one or more applets 105. The card-integrated memory 104 may also include an application transaction counter (not shown) to keep track of a proper sequence of read and/or write transaction associated with the contactless card 101. The contactless card 101 may further comprise a Near Field Communication (NFC) interface/tag 107 to facilitate NFC communication with an NFC reader (e.g., reader unit 111 of the user mobile device 110 via NFC link 109.) A contactless transaction (e.g., a read and/or write operation directed at the contactless card 101) may be facilitated by the reader unit 111 of the mobile user device 110, by bringing the contactless card within an NFC range of the mobile device (e.g., by tapping the contactless card on a reader of the user mobile device).

In reference to FIG. 1, the user communication device 110, may include one or more processors 112 (e.g., one or more microprocessors), coupled to memory 113, which may be, for example, random access memory (RAM), read-only memory (ROM), programmable read-only memory (PROM), erasable programmable read-only memory (EPROM), and/or electrically erasable programmable read-only memory (EEPROM), and the user device 110 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

Memory 113 may include one or more applications 114, for facilitating NFC-based exchange of data with an external source within an NFC field of the mobile device. Accordingly the mobile device 110 may be configured for wireless communication with the contactless card 101 via a short-range wireless connection (e.g., NFC), and network communication, via a network 140 with one or more remote servers (e.g., server 120). The processor 112 may be a processor, a microprocessor, or other processor, and the user communication device 110 may include one or more of these processors. The processor 112 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The user communication device 110 may further include one or more Input/Output (I/O) devices 117 for capturing user inputs and displaying one or more information records and/or notification messages to the user. For example, I/O devices 117 may include at least one display and input device. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user (mobile) device that is available and supported by the device, such as a touch-screen, keyboard, mouse, cursor-control device, touch-screen, microphone, digital camera, video recorder or camcorder.

I/O devices 117, associated with the user device 110, may include an electronic reader unit 111 for capturing information via one or more short range communications protocols such as Near Filed Communication (NFC). The user device 110 may be configured to transmit one or more read/write instruction to the contactless card 101, via NFC link 109. The user device 110 may be a network-enabled computer device, with a network communication interface. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other network-enabled computing or communications devices. For example, network-enabled computing devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. It is further understood that the user (mobile) device may be of any type of device that supports the communication and display of data and user input. The present disclosure is not limited to a specific number of user devices, and it is understood that the system 100 may include a single client device or multiple client devices.

Referring back to FIG. 1, the memory 113, of the user communication device 110, may be configured to store one or more software applications, such as applications 114, and other data, such as user's private data and financial account information. Applications 114 may comprise for example, a NFC reading application and/or API 115 for direct communication of data bytes with the contactless card 101. In some embodiments, applications 114 may further operate as an intermediary application for facilitating communication between server 120 (e.g., process 123) and contactless card 101 (e.g., applet 105). Applications 114, stored on user communication device 110, may further comprise a mobile browser 116 with a browser extension (e.g., WebNFC) to enable implementation of communication between the server 120 and contactless card 101 via generic NFC protocols such as a WebNFC API. The WebNFC-enabled mobile browser 116 allows a website (loaded on the user device such as the mobile device 110 and/or computing device 118) to communicate (read and/or write) with an NFC tag (e.g., NFC interface/tag 107 of contactless card 101) through the device's NFC reader (e.g., reader unit 111 of the mobile device 110 and/or the reader unit 119 of the computing device 118), using NDEF messaging. Therefore, as described with respect to the example 100 of FIG. 1, the user device running the webNFC-based browser for communication of server-generated data to a user contactless card 101, may correspond to a user mobile device 110 (having a reader unit 111) and/or a user computing device 118 (such as a desktop, laptop, and/or tablet) equipped with a reader unit 102. This allows the described operation to take place without a specialize client application on the user device.

One aspect of the described process as facilitated by the system configuration 100 may correspond to the distributed transmission of diagnostic read/write codes, by server 120, to the reader applications (e.g., mobile application 115 and/or webNFC enabled browser applications 116 and/or 119 stored on mobile device 110 and computing device 118, respectively) installed across a distributed population of user devices. The diagnostic read/write codes, generated, for example, by server 120, may be operative to retrieve, for analysis, diagnostic information, such as a version number data corresponding to one or more applets (e.g., applet files 105), stored on the contactless card 101.

The server 120 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 120 may include a processor 121, a memory 122, and an application 123. The processor 121 may be a processor, a microprocessor, or other processor, and the server 120 may include one or more of these processors. The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the server 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as user's private data and financial account information.

The application 123 may comprise one or more software applications comprising instructions for execution on the server 120. In some examples, the server 120 may execute one or more applications, such as software applications, that enable, for example, network communications with one or more components of the system 100, transmit and/or receive data, and perform the functions described herein. Upon execution by the processor 121, the application 123 may provide the functions described in this specification, specifically to execute and perform the steps and functions in the process flows described below. Such processes may be implemented in software, such as software modules, for execution by computers or other machines. The application 123 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 120 may further include a display and input devices (not shown). The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the server 120 that can be available and supported by the server 120, such as a touch-screen, keyboard, mouse, cursor-control device, touch-screen, microphone, digital camera, video recorder or camcorder. These devices may be used to enter information and interact with the software and other devices described herein.

System 100 may include one or more networks 140. In some examples, the network 140 may be one or more of a wireless network, a wired network or any combination of wireless network and wired network, and may be configured to connect the user devices (e.g., mobile device 110 and/or computing device 118), the server 120 and the database 150. For example, the network 140 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 140 may include, without limitation, telephone lines, fiber optics, IEEE Ethernet 902.3, a wide area network, a wireless personal area network, a LAN, or a global network such as the Internet. In addition, the network 140 may support an Internet network, a wireless communication network, a cellular network, or the like, or any combination thereof. The network 140 may further include one network, or any number of the exemplary types of networks mentioned above, operating as a stand-alone network or in cooperation with each other. The network 140 may utilize one or more protocols of one or more network elements to which they are communicatively coupled. The network 140 may translate to or from other protocols to one or more protocols of network devices. Although the network 140 is depicted as a single network, it should be appreciated that according to one or more examples, the network 140 may comprise a plurality of interconnected networks, such as, for example, the Internet, a service provider's network, a cable television network, corporate networks, such as credit card association networks, and home networks. The network 140 may further comprise, or be configured to create, one or more front channels, which may be publicly accessible and through which communications may be observable, and one or more secured back channels, which may not be publicly accessible and through which communications may not be observable.

System 100 may include a database 150. The database 150 may be one or more databases configured to store data, including without limitation, private data of users, financial accounts of users, identities of users, transactions of users, and certified and uncertified documents. The database 150 may comprise a relational database, a non-relational database, or other database implementations, and any combination thereof, including a plurality of relational databases and non-relational databases. In some examples, the database 150 may comprise a desktop database, a mobile database, or an in-memory database. Further, the database 150 may be hosted internally by the server 120 or may be hosted externally of the server 120, such as by a server, by a cloud-based platform, or in any storage device that is in data communication with the server 120.

In some examples, exemplary procedures in accordance with the present disclosure described herein can be performed by a processing arrangement and/or a computing arrangement (e.g., a computer hardware arrangement). Such processing/computing arrangement can be, for example entirely or a part of, or include, but not limited to, a computer/processor that can include, for example one or more microprocessors, and use instructions stored on a non-transitory computer-accessible medium (e.g., RAM, ROM, hard drive, or other storage device). For example, a computer-accessible medium can be part of the memory of the contactless card 101, the user device 110, the server 120, the network 140, and the database 150 or other computer hardware arrangement.

In some examples, a computer-accessible medium (e.g., as described herein, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

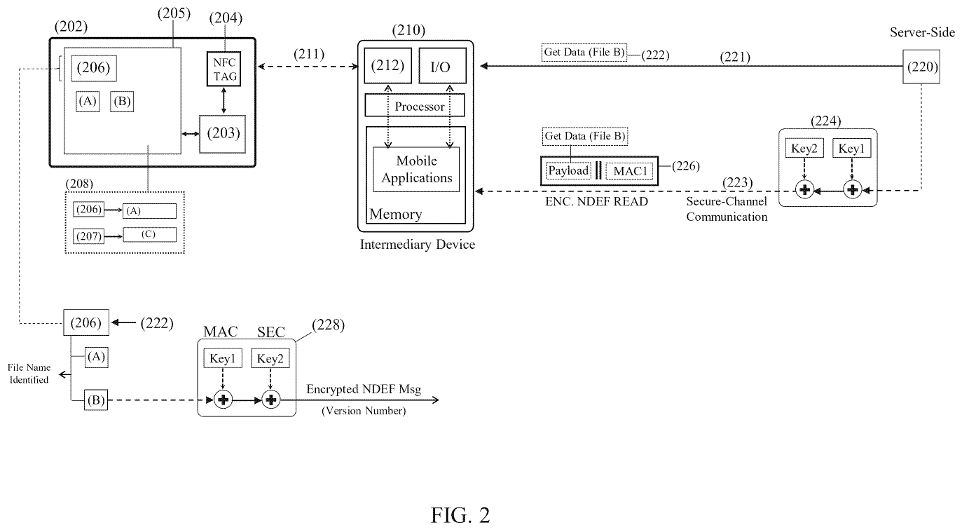

FIG. 2 illustrates an exemplary process 200 for retrieving an applet version data, stored onto a contactless card 202 via a mobile application communicating with the applet 206 over a NFC connection 211 established between the mobile device 210 and the contactless card 202. In some embodiments the mobile device may serve as an intermediary device for passing on server generated instruction/commands, across network connected session, to the contactless card. Referring back to FIG. 2, example 200 illustrates a contactless card 202 having a processor 203 communicatively coupled with an NFC tag/interface 204 and a memory 205. Memory 205 may store a NDEF applet 206 having one or more data files and/or applet file components stored as files A and B. Contactless card 202 may also store one or more other applets (e.g., 207) associated with one or more corresponding data files/components (e.g., data file C). The contactless card 202 may further store a capability container file 208 which provides a listing of applet files and readable data files associated with each applet file (e.g., represented as an applet tag).

In example 200 of FIG. 2, the version number data, associated with the NDEF applet 206, which is generally included as part of the applet code, may be provided as an accessible but hidden data parameter which may be retrievable during the active life cycle of the contactless card 202. According to one embodiment, the version number data may be stored in a hidden data file corresponding to a data file or applet component not exposed in the capability container file 208 stored on the contactless card. For example, with reference to FIG. 2, the version number, is stored in a separate proprietary folder (e.g., file B). Proprietary files may include data that may not be readily made available and thus may not be specified in the container folder 208 In the exemplary illustration 200, data file B may be used for storing version number data associated with applet file 206. Therefore data file B maybe represented with a file identifier that is not included in capability container folder 208 as illustrated in FIG. 2.

Although the version number data may be stored in a hidden file (stored as a separate NDEF readable data file not exposed in the capability file container), there may be need to access this data given its diagnostic utility. In such situations, as illustrated in FIG. 2, the version number data may then be retrieved via a read or a data request command 221 directed at the hidden file B (e.g., specifying the hidden file name in the command). In some embodiments, the read command may be generated by a server-side process 220.

In most cases, a default read command directed at NDEF applet may be associated with generation of an encrypted one-time password (OTP) password using data read from a corresponding file (e.g., file (A)) which may be specified in association with the NDEF applet 204 (e.g., type 4 NDEF tag) in the capability container file 208 stored on the contactless card. The encrypted (OTP) may then be retrieved/read via a NFC link 211 established between the intermediary device 210 and transmitted, across a secure session, to the remote server for verification. However, with reference to example 200 of FIG. 2, data file storing applet version number (e.g., file B) is excluded from the capability container file 208. Therefore NFC-based retrieval of applet version data may require an explicit identification of the hidden file name not referenced in the NDEF capability file 208 stored on the contactless card 202. This is illustrated for example, by a server-generated data retrieval (e.g., Get Data) command 221, which explicitly identifies file B as a read command parameter.

Referring back to example 200, the data retrieval/read request 221 may be generated by a server-side process 220. The read request 221 may correspond to a (Get Data) command specifying file B as data source. As described above, the read command may be transmitted to the contactless card 202 via the intermediary device 210. The read command (comprising of one or more application protocol data units (APDU)) may be sent from a client application executing by the server-side process 220 and/or the mobile client-side application, as APDU command 222, to the contactless card 202. The get data APDU command 222 may be relayed to the contactless card 202 via the intermediary device 210. The transmission of the data packet 222 to the intermediary mobile device 210 (with NFC connectivity 211 to the contactless card 202) may be facilitated across a network session 221. With reference to one exemplary implementation, the read request data packet 222 may be sent as clear text across an un-encrypted network session 221. The exemplary implementation 200 of FIG. 2 further illustrates the applet's process response to an incoming read command (e.g., APDU read request 222). Responsive to the incoming read request 222, processor 203 of the contactless card may retrieve data corresponding to the identified data file (e.g., file B) for transmission through the NFC tag 204, to a reader 212 of the intermediary device 210 (e.g., via NFC link 211 established to the NFC tag 204 of the contactless card 202 and a reader unit 212 of the mobile device 210. Since applet version number may include information with regard to the implemented cryptographic process the version number data may be encrypted with secure card keys (e.g., key 1 for MAC generation and key 2 for session encryption) prior to transmission to the intermediary device 210. As illustrated in FIG. 2, the secure session may be established via cryptographic process 228.

FIG. 2 further illustrates an embodiment wherein an incoming NDEF read request (e.g., Get data in File B) is transmitted via a secure channel 223 with the contactless card 202 (as facilitated by the intermediary device 210). As such, in some embodiments the server-side process 220 for generation and communication of NDEF commands may comprise a process 224 for establishing a secure communication channel 223 to enable communication of encrypted data with the contactless card 202. For example, the secure channel 223 may be implemented by a secure session encryption process 224 for encrypting a payload associated with a generated NDEF and/or APDU command (e.g., corresponding to the illustrated concatenation of the payload with a message authentication code (MAC)). In example 200, this is illustrated by the cryptogram 226 comprising a message authentication code (MAC1). However, this requires that the secure session card keys (e.g., Key 1 and Key2) are known by the remote server process 224. (e.g., executing on server 120).

Accordingly, cryptogram 226 may correspond to an NDEF read command with an encrypted payload, for reading one or more data files associated with an NDEF application (e.g., NDEF applet 206) running on the contactless card 202. With respect to the illustrated example 200 in FIG. 2, the NDEF message with an encrypted payload (e.g., cryptogram 226) may include a specific command for data retrieval (e.g., Get data command) and may further identify a file name as a command parameter. In example 200 file B is identified explicitly in the encrypted payload of the NDEF and/or APDU-based read command which is transmitted via a network connection to the intermediary device 210. Upon receiving the NDEF message comprising the encrypted payload, the contactless card 202 may decrypt the read cryptogram using its card keys (e.g., Key 2 for session decryption and key 1 for MAC validation) and identifies the corresponding data file. The requested data may then be retrieved by processor 203 of the contactless card and transmitted via the NFC tag 204 to a reader 212 of the intermediary device (mobile device 210) across NFC link 211.

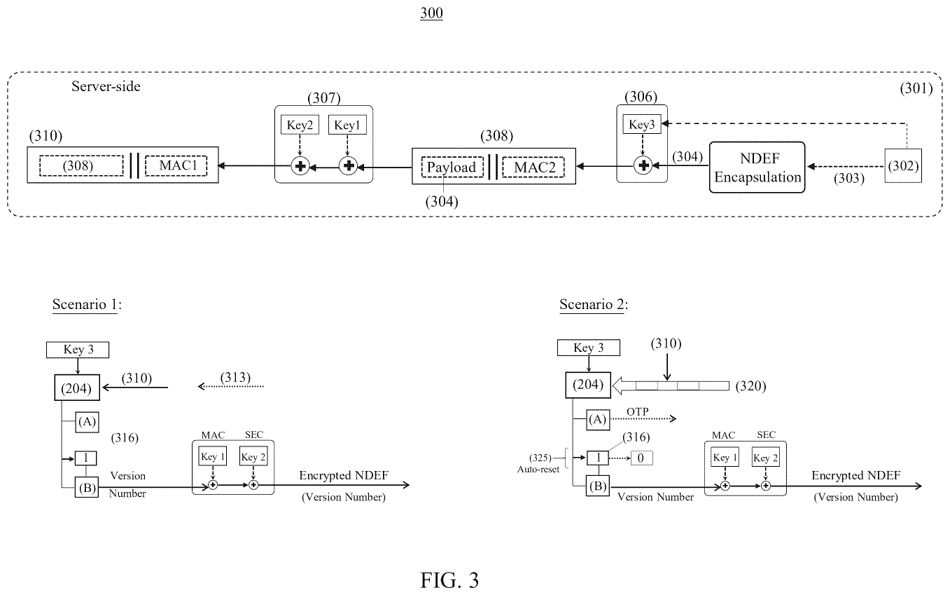

As described earlier and further illustrated in FIG. 3, the read command for retrieval of proprietary data from the contactless card, whether encrypted with secure session keys or transmitted in clear text, may be encapsulated in an NDEF message to enable implementation via technologies such as WebNFC. Accordingly, the generated NDEF command, implemented in accordance with the exemplary embodiment 200, can be used inside of a WebNFC capability to enable a more limited implementation of NDEF which may only allow NDEF based read and write commands.

One application of the described arrangement in FIG. 2 may involve transmission of coded instruction (e.g., by a server-side process 220) to a distributed set of user mobile devices running a reader application, the instructions maybe generated as NDEF encapsulated APDU packets and may correspond to a hidden file number for returning the version number during active card operation for analysis. As such, one operational aspect associated with the system implementation 200 may correspond to server-initiated distributed retrieval of diagnostics data (such as an applet version number) for analysis and diagnostic purposes.

FIG. 2 illustrates an exemplary embodiment directed at using hidden file names (e.g., excluded from the capability container) and/or proprietary files for storage of applet version data in an implementation that facilitates acquisition of version information associated with an applet (e.g., type 4 NDEF tag) in a secure and streamlined manner. Therefore, with reference to the exemplary embodiment 200, data file B storing version number information for applet 206, may not be associated with any other permissible/access parameters other than not being referenced in the capability container (which may provide a measure of security against accidental or unintended reads of the applet version number.) Another embodiment of the present disclosure whereby the version number storing file is associated with controllable read permission and access parameters is illustrated in FIG. 3.

FIG. 3 illustrates an overview of an exemplary server-side and card-side process flow for implementing a command-based access control of a sensitive and/or proprietary data stored on a contactless card. In the exemplary embodiment 300, access control to an access-restricted data file (e.g., data file storing an applet version number) may be implemented by using a data write operation (e.g., update binary command) in order to set a value of an operational parameter such as an access flag that may be associated with one or more applet file and/or applet file components stored on the contactless card.

Referring back to FIG. 3, an exemplary server side operation for generation of an encrypted write command is shown by the overview process flow 301. The encrypted write command associated with the exemplary operational flow 301, may be securely used, for example, for setting a control parameter associated with operation of the contactless card (e.g. contactless card 202) and/or one or more applets stored thereon. Referring back to the exemplary server-side operation 301, a server application and/or a command-issuing process 302 generates a write command 303 (e.g., update binary command) for turning on an access permission for a specific data file stored on the contactless card (e.g. writing an access-flag bit associated with a specific data file on the contactless card.)

The write command 303 may be encapsulated into an NDEF message 304. Encapsulating the write command 301 in a NDEF message enables an implementation for communication via a mobile browser based on WebNFC. The NDEF encapsulated write command 305 may be operative to alter operation of the contactless card (e.g., by setting values of operational parameter stored on the contactless card) and as such may require a security feature. Accordingly, the write command, as shown in the exemplary embodiment 300, is processed by a secure channel protocol (process 306) using a secret key (e.g., key 3). To generate a message authentication code (e.g. MAC2) for the NDEF encapsulated write command 304.

As described MAC2 may be implemented by a third key (e.g. Key 3) which may represent a secret key on the server for encrypting or signing the write command with a distinct message authentication code (MAC). Key 3 that is distinct from the session encryption key and MAC generation key used for establishing a secure communication channel (e.g., keys 1 and key 2). The NDEF data packet 308 (for secure write operation) comprising a payload (e.g., the write command) concatenated with a distinct message authentication code (e.g., MAC2 generated with key 3)), may then be encrypted with secure session protocol/process 307 for card communication. The resulting encrypted data packet (e.g., cryptogram 310) may then be communicated to the contactless card 202 via an intermediary NFC reader device (e.g., user mobile device 210 running a mobile NFC application). In some embodiments, NDEF write instruction with an encrypted payload (e.g., data packet 308) may be generated by the one or more applications executing on a user mobile device with NFC connectivity to the contactless card.

According to some embodiments, cryptogram 310 generated by encrypting the data packet 308 (representing an NDEF write instruction with a unique MAC) with secure session protocol using card keys (e.g., key 1 for MAC generation and key 2 for session encryption) may be communicated to the contactless card applet (e.g., NDEF applet 204) via a mobile NFC application communicating with the applet over a NFC connection established between the intermediary device and the contactless card as shown in FIG. 2. In some embodiments, cryptogram 310 may be communicated to the contactless card applet (e.g., NDEF applet 204) via WebNFC-enabled browser communication with a mobile web browser communicating with the applet over a NFC connection established between the mobile device and the contactless card.

As described above, with respect to server-side operation 301, the generated cryptogram 310 corresponds to an NDEF-encapsulated write command, with encrypted payload, directed to a contactless card applet (e.g., NDEF applet 204). In accordance with an embodiment, the encrypted write command may be operative to set one or more control parameters associated with operation of one or more applets stored on the contactless card. The control parameter, with respect to the illustrated example in FIG. 3, correspond to file access permissions for one or more applet files and/or applet file components (data files associated with each applet). This is further illustrated with respect to the operation of applet 204 (e.g., stored on the contactless card 202) in response to receiving cryptogram 310 comprising a secure NDEF write command.

Referring back to FIG. 3, with respect to card-side operations, an access-flag bit 316 (e.g., stored in a data register on the internal memory of the contactless card) may signify an access-state of a data file. The access flag 316 may be turned off (e.g. set to a value of 0) to disable data access to file (B), or turned on (set to a value of 1) to enable data access to file (B) which stores version number data for NDEF applet 204 in an exemplary embodiment of the disclosed system and process. FIG. 3 illustrates two operational scenarios (scenario 1 and scenario 2), for command-based retrieval of access-restricted data from the contactless card, As shown in FIG. 3, in both scenarios the NDEF write command (associated with payload of cryptogram 310) is validated, by the receiving NDEF applet on the contactless card (e.g., applet 204) using the secret key (e.g., key 3) which may be diversified for and stored on the contactless card (e.g., contactless card 202).

In the implementation illustrated under scenario 1, the NDEF write command with an encrypted payload (e.g., cryptogram 310) may be transmitted as a single command. Responsive to receiving cryptogram 310 and validating the associated MAC (E.g., MAC2) using the secret key (e.g. key 3) stored on the contactless card, the access flag 316 associated with data file (B) is set to 1. Accordingly, by unlocking the applet version data for NFC retrieval, the NDEF message 310, comprising an encrypted payload, may be operative to modify a response of the contactless card and/or applet 204 to a subsequent read message 313, such that next time a read command is generated (e.g. responsive to subsequent read request 313), the version number is returned. The version number may be encrypted with secure card session keys to ensure secure communication.

In accordance with some embodiments of the present disclosure, subsequent read request 313 may correspond to a data retrieval request (e.g., Get Data) for a specific applet data file identified by a file identifiers/names in the command. In some embodiments the subsequent read request 313 may correspond to a data retrieval request for applet data files identified in a capability container stored on the contactless card. In some embodiments, the subsequent read request 313 may correspond to an OTP read request (e.g., read request for applet generated OTP password), modified to initiate a data retrieval from one or more applet data files (e.g., in addition to data file associated with OTP password generation). In some embodiments, the subsequent read request 313, may correspond to a NDEF read of one or more files listed in the capabilities container with respect to an applet stored on the contactless card (e.g., NDEF applet 204). With respect to the latter, the applet version number storing file may be identified in the capability container as this poses no security risk since access is determined based on a access-flag value.

In the implementation illustrated under scenario 2, the NDEF write command, comprising an encrypted payload (e.g., cryptogram 308) may be inserted into a multi-component read command 320, operative to set the access flag of a data file (e.g., file (B)) and retrieve the stored data (e.g., applet version number) during a single actuation of the card. The read command 320 may further correspond to a modified OTP read request including a read request for an OTP password associated with reading a applet data file (e.g., file (A), the NDEF write command 308 with a distinct MAC, an additional data retrieval instruction to further return the version number based on the access flag set by a prior write instruction (e.g., NDEF write command 308).

In some embodiments, every read request directed at an access-restricted data file (e.g., data file (B) storing NDEF applet version number) may be followed by a verification of the flag value (access flag 316), If access flag is set the corresponding data (e.g., applet version number) is returned. In some embodiments the access-flag associated with the applet version data, may be reset automatically every time a read operation is executed such that it would be disallowed during a subsequent NDEF read (e.g., auto-reset operation 325). For example, with respect to the exemplary scenario 1, the reset of the access-value may occur following the read request 313. In some embodiments, the access-flag value, once written via an NDEF write command (e.g., cryptogram 310), may persist over subsequent actuations of the contactless card until it is re-written via another NDEF write operation (wherein the flag is not reset automatically but through a command packet sent to the applet with instruction to reset, turn on or turn off the flag bit.

In the exemplary embodiment illustrated in FIG. 3, since access-state of a proprietary data file is actively controlled via write instruction to the contactless card, including of proprietary file names (e.g., any data file storing sensitive information) in the capability file may not pose a security risk. As such, in some embodiments the access-restricted file may not be stored as a hidden file (e.g., excluded from being listed in the capability file). In some embodiments active access-control via write commands (e.g., control bits that set an operational aspect of the contactless card) as illustrated in FIG. 3, may be provided in addition to the hidden file name to protect sensitive data stored on a contactless card while providing streamlined secure access to data for an authorized party.

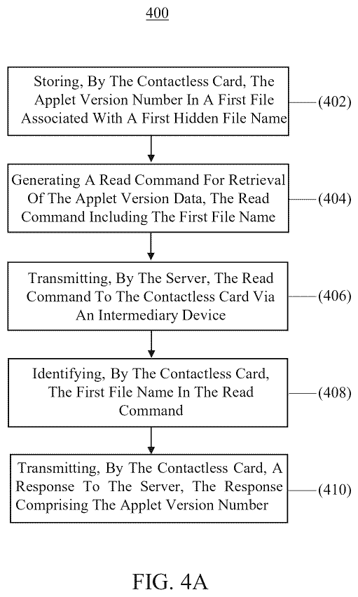

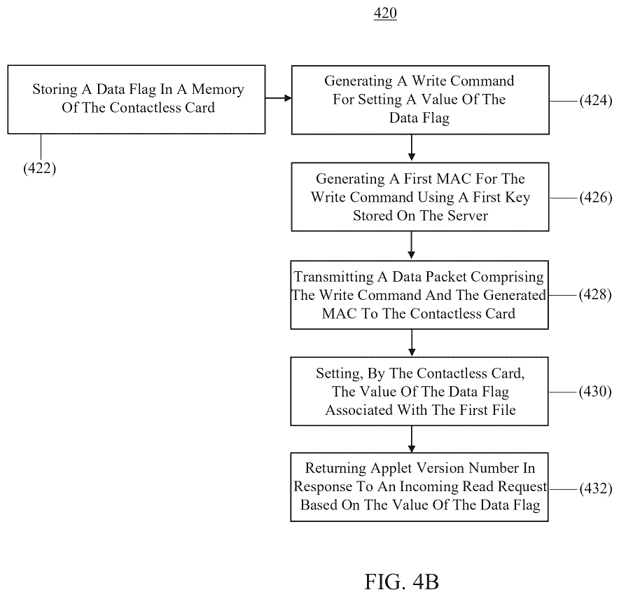

FIG. 4A illustrates an exemplary operation flow diagram 400 for implementing secure verification of an applet version number stored on a contactless card. According to the exemplary process flow 400, at step 402, applet version number may be stored on a first file associated with a first file name, the first file is stored on the contactless card, however, the first file name may not referenced in a capability container stored on the contactless card for security purposes and in order to protect against unintentional reads of the proprietary version number. At step 404, a read command for retrieval of the applet version data may be generated by a server in communication with the contactless card via an intermediary mobile application running on a user mobile device. The read command may comprise one or more parameters including the first file name. The read command may be encapsulated into the NDEF process and transmitted to the contactless card via the intermediary mobile application, as shown in step 406. Upon receiving the NDEF read command, the contactless card may identity the first file name in the read command, and transmit, a response back to the server, as shown by steps 408 and 410. With respect to step 410, the response may comprise an applet version number stored in the first file, wherein the response is provided, by the contactless card, based on identifying the first file name in the read command.

FIG. 4B illustrates an exemplary operation flow diagram 400 for implementing active retrieval of an applet version number from a contactless card. According to the exemplary process flow 420, at step 422 a data flag may be stored in a memory of the contactless card, wherein a value of the data flag corresponds to an access state of a first file storing the applet version number. The applet version number may correspond to an NDEF applet stored on the contactless card. At step 424 a write command for setting a value of the data flag may be generated, by a server. Prior to transmission of the write command to the contactless card, the write command may be encapsulated into the NDEF process and a message authentication code (MAC) may be computed for the NDEF record comprising the write command, as shown in step 426. The generation of MAC for the write command may be facilitated by a distinct key (e.g., secret key) that is different than the card keys used for establishing a secure communication session between the contactless card and, for example, a remote server. The resulting NDEF data packet, comprising the write command, for setting the data flag associated with an applet data file (e.g., first file) stored on the contactless card, and the uniquely generated MAC, may be transmitted to the contactless card, at step 428. In some embodiments communication between the command-issuing server and the contactless card may be facilitated by an intermediary mobile application running on a user device. The intermediary mobile application running on the user device may have network connectivity to the server and short-range wireless connectivity (e.g., NFC) to the contactless card. Upon receiving the NDEF data packet, the contactless card may decrypt the received message, using card keys, and validate the retrieved MAC associated with the write command using the secret key, independently stored on the contactless card.

Upon validation of the MAC associated with the write command, the value of the access flag associated with the first file may be set by the contactless card, as shown in step 430, and at step 432 an applet version number may be returned, by the contactless card, in response to one or more incoming read request based on the value of the data flag.

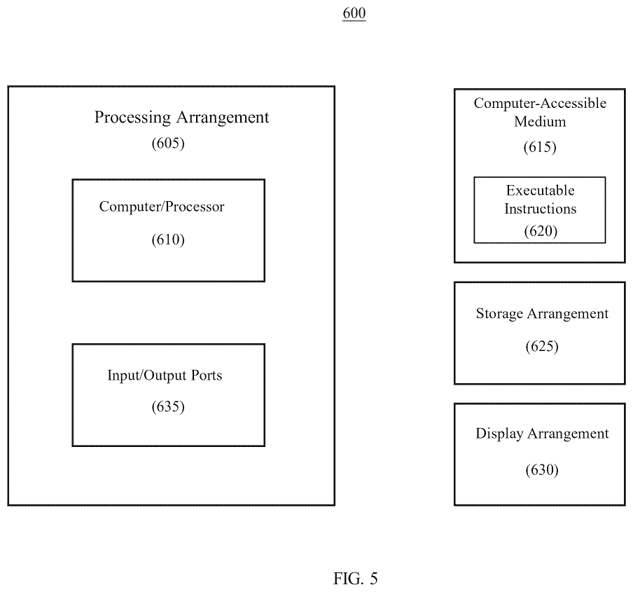

FIG. 5 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement 505 may be configured for computing a trajectory of the contactless within an optical FOV generated by a camera unit of user device and projecting a final placement of the contactless against a reader unit of the user device at a point at which the camera feed goes dark). Such processing and/or computing arrangement 505 can be, for example entirely or a part of, or include, but not limited to, a computer and/or processor 510 that can include, for example one or more microprocessors, and use instructions stored on a computer-accessible medium (e.g., RAM, ROM, hard drive, or other storage device).

As shown in FIG. 5, for example a computer-accessible medium 515 (e.g., as described herein above, a storage device such as a hard disk, floppy disk, memory stick, CD-ROM, RAM, ROM, etc., or a collection thereof) can be provided (e.g., in communication with the processing arrangement 505). The computer-accessible medium 515 can contain executable instructions 520 thereon. In addition or alternatively, a storage arrangement 525 can be provided separately from the computer-accessible medium 515, which can provide the instructions to the processing arrangement 505 so as to configure the processing arrangement to execute the exemplary procedures, processes, and methods, as described herein above, for example.

Further, the exemplary processing arrangement 505 can be provided with or include an input and/or output ports 535, which can include, for example a wired network, a wireless network, the internet, an intranet, a data collection probe, a sensor, etc. As shown in FIG. 5, the exemplary processing arrangement 505 can be in communication with an exemplary display arrangement 530, which, according to certain exemplary embodiments of the present disclosure, can be a touch-screen configured for inputting information to the processing arrangement in addition to outputting information from the processing arrangement, for example. Further, the exemplary display arrangement 530 and/or a storage arrangement 525 can be used to display and/or store data in a user-accessible format and/or user-readable format.

As used herein, the term “card” is not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

Systems and methods described herein can provide a system and configuration for performing an optimal NFC read of a contactless card by a reader device. Once a NFC link is established the wireless connectivity between the contactless card and the reader can permit, without limitation, financial transactions (e.g., credit card and debit card transactions), account management transactions (e.g., card refresh, card replacement, and new card addition transactions), membership transactions (e.g., joining and departing transactions), point of access transactions (e.g., building access and secure storage access transactions), transportation transactions (e.g., ticketing and boarding transactions), and other transactions.

In some aspects, the techniques described herein relate to a system for enabling applet version identification during active life cycle of a contactless card, the system including: executing a first applet, a contactless card including a processor; a memory storing a plurality of cryptographic key including a first key, a second key, a third key, a first data file and one or more data parameters including an access flag for the first data file, wherein the first data file stores an applet version number for a first applet; an NFC tag for wireless communication with an intermediary device running a first application; and a server communicatively coupled with the contactless card via the intermediary device; the server including: a processor; a memory storing an second application in communication with the first application running on the intermediary device, and one or more cryptographic keys including the first key, wherein the processor of the server is configured to: generate a write command for setting a value of the access flag associated with the first file; generate a message authentication code (MAC) for the write command using the first key; transmit a data packet including the write command and the generated MAC, via the first application, to the first applet executing on the contactless card, wherein the data packet is validated by the first applet using the first key, and wherein upon successful validation of the data packet, the access flag is set to the value specified in the write command.

In some aspects, the techniques described herein relate to a system, wherein the setting of the access flag initiates the contactless card to return the applet version number in response to a subsequent read command.

In some aspects, the techniques described herein relate to a system, wherein the access flag is automatically reset following a value return operation initiated by the write command.

In some aspects, the techniques described herein relate to a system, wherein the processor of the server is further configured to: encrypt the data packet using the first key and the second key prior to transmission to the first applet, the first key and the second key being stored on the server.

In some aspects, the techniques described herein relate to a system, wherein the write command is encapsulated in near-field data exchange format (NDEF) prior to the generation of the MAC using the first key.

In some aspects, the techniques described herein relate to a method for secure verification of an applet version number stored on a contactless card, the method including: storing, by the contactless card, the applet version number in a first file associated with a first file name, wherein the first file name is not referenced in a capability container stored on the contactless card; generating, by a server, a read command for retrieval of the applet version data, wherein the read command includes one or more parameters including the first file name; transmitting, by the server, the read command to the contactless card; transmitting, by the contactless card, a response to the server, the response including the applet version number, wherein the response is provided, by the contactless card, based on identifying the first file name in the read command.

In some aspects, the techniques described herein relate to a method, wherein the read command corresponds to an application protocol data unit (APDU) command.

In some aspects, the techniques described herein relate to a method, wherein the response is encrypted by the contactless card using the second key and the third key, prior to transmission to the server.

In some aspects, the techniques described herein relate to a method, wherein the first applet correspond to an NDEF applet.

In some aspects, the techniques described herein relate to a method, wherein the transmitting of the read command, by the server, to the contactless card is facilitated by the first application running on the intermediary device with network connectivity to the server and NFC connectivity to the contactless card.

In some aspects, the techniques described herein relate to a method for active retrieval of an applet version number from a contactless card, the method including: storing a data flag in a memory of the contactless card, wherein a value of the data flag corresponds to an access state of a first file storing the applet version number; generating, by a server, a write command for setting a value of the data flag; generating, by the sever, a first message authentication code (MAC) for the write command, using a first key stored on the server; transmitting, by the server, a data packet including the write command and the generated MAC, to the contactless card; verifying, by the contactless card, the first MAC associated with the write command, using the first key stored on the contactless card; setting, by the contactless card, the value of the data flag associated with the first file; returning the applet version number in response to one or more incoming read request based on the value of the data flag.

In some aspects, the techniques described herein relate to a method, wherein the applet version number is encrypted, by the contactless card, using a second key and a third key stored on the contactless card, prior to transmission in response to a read request.

In some aspects, the techniques described herein relate to a method, wherein the second key is associated with a generation of a second MAC that is distinct from the first MAC, and the third key corresponds to a session encryption key for communication with the contactless card.

In some aspects, the techniques described herein relate to a method, wherein the value of the data flag is reset automatically by the contactless card, in response to each read out of the applet version number.

In some aspects, the techniques described herein relate to a method, wherein the value of data flag persist across a plurality of read command until written by a write command.

In some aspects, the techniques described herein relate to a method, wherein the write command is encapsulated, by the server, into an NDEF record, prior to the generation of the first MAC.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

Throughout this specification, reference is made to data communication using NFC and NDEF, however, the present disclosure is not limited thereto. Rather, it is understood that the present disclosure encompasses data communication by any suitable format.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A system for enabling applet version identification during active life cycle of a contactless card, the system comprising:
a contactless card comprising
a processor;
a memory storing a plurality of cryptographic key comprising a first key, a second key, a third key, a first data file and one or more data parameters comprising an access flag for the first data file, wherein the first data file stores an applet version number for a first applet;
an NFC tag for wireless communication with an intermediary device running a first application; and
a server communicatively coupled with the contactless card via the intermediary device; the server comprising:
a processor;
a memory storing a second application in communication with the first application running on the intermediary device, and one or more cryptographic keys comprising the first key, wherein the processor of the server is configured to:
generate a write command for setting a value of the access flag associated with the first file;
generate a message authentication code (MAC) for the write command using the first key;
transmit a data packet comprising the write command and the generated MAC, via the first application, to the first applet executing on the contactless card, wherein the data packet is validated by the first applet using the first key, and wherein upon successful validation of the data packet, the access flag is set to the value specified in the write command.

2. The system of claim 1, wherein the setting of the access flag initiates the contactless card to return the applet version number in response to a subsequent read command.

3. The system of claim 2, wherein the access flag is automatically reset following a value return operation initiated by the write command.

4. The system of claim 1, wherein the processor of the server is further configured to: encrypt the data packet using the first key and the second key prior to transmission to the first applet, the first key and the second key being stored on the server.

5. The system of claim 1, wherein the write command is encapsulated in near-field data exchange format (NDEF) prior to the generation of the MAC with the first key.

6. The system of claim 1, wherein a communication between the server and the contactless card is facilitated by the first application running on the intermediary device.

7. The system of claim 6, wherein the intermediary device comprises a user communication device with network connectivity to the server and NFC connectivity to the contactless card.

8. The system of claim 6, wherein the intermediary device comprises a user computing device with network connectivity to the server and NFC connectivity to the contactless card.

9. The system of claim 1, wherein the first application comprises a mobile WebNFC-based browser stored on the intermediary device, and the second application comprises a WebNFC-based browser application stored on the server.

10. A method for secure verification of an applet version number stored on a contactless card, the method comprising:
storing, by the contactless card, the applet version number in a first file associated with a first file name, wherein the first file name is not referenced in a capability container stored on the contactless card;
generating, by a server, a read command for retrieval of the applet version number, wherein the read command comprises one or more parameters including the first file name;
transmitting, by the server, the read command to the contactless card; and
transmitting, by the contactless card, a response to the server, the response comprising the applet version number, wherein the response is provided, by the contactless card, based on identifying the first file name in the read command.

11. The method of claim 10, wherein the read command corresponds to an application protocol data unit (APDU) command.

12. The method of claim 11, wherein the response is encrypted by the contactless card using one or more keys, prior to transmission to the server.

13. The method of claim 10, wherein the first applet corresponds to an NDEF applet.

14. The method of claim 10, wherein the transmitting of the read command, by the server, to the contactless card is facilitated by a first application running on an intermediary device with network connectivity to the server and NFC connectivity to the contactless card.

15. A method for active retrieval of an applet version number from a contactless card, the method comprising:
storing a data flag in a memory of the contactless card, wherein a value of the data flag corresponds to an access state of a first file storing the applet version number;
generating, by a server, a write command for setting a value of the data flag;
generating, by the server, a first message authentication code (MAC) for the write command, using a first key stored on the server;
transmitting, by the server, a data packet comprising the write command and the generated MAC, to the contactless card;
verifying, by the contactless card, the first MAC associated with the write command, using the first key stored on the contactless card;
setting, by the contactless card, the value of the data flag associated with the first file; and
returning the applet version number in response to one or more incoming read request based on the value of the data flag.

16. The method of claim 15, wherein the applet version number is encrypted, by the contactless card, using a second key and a third key stored on the contactless card, prior to transmission in response to a read request.

17. The method of claim 16, wherein the second key is associated with a generation of a second MAC that is distinct from the first MAC, and the third key corresponds to a session encryption key for communication with the contactless card.

18. The method of claim 15, wherein the value of the data flag is reset automatically by the contactless card, in response to each read out of the applet version number.

19. The method of claim 15, wherein the value of data flag persists across a plurality of read commands until written by a write command.

20. The method of claim 16, wherein the write command is encapsulated, by the server, into an NDEF process, prior to the generation of the first MAC.
